(19) United States
(12) Patent Application Publication
(10) Pub. No.: US 2025/0381904 A1
(43) Pub. Date: Dec. 18, 2025

(54) EZ UNLOAD TRAILER

(71) Applicant: ThinkDesignCreate Inc., Ariss (CA)

(72) Inventors: Tim Sommerfeld, Ariss (CA); Sean Zylstra, Kitchener (CA)

(21) Appl. No.: 19/242,244

(22) Filed: Jun. 18, 2025

Related U.S. Application Data
(60) Provisional application No. 63/661,086, filed on Jun. 18, 2024.

(51) Int. Cl. B60P 1/38

(52) U.S. Cl. CPC B60P 1/38

(57) ABSTRACT

Described is a trailer-like assistive unloading system with an adjustable handle and a rotatable element wherein rotation of the rotatable element facilitates unloading. The system includes a trailer structure supported by wheels and a rotatable element mounted on a pivot arm connected to a dispensing terminus of the trailer structure. There is a mat wound about the rotatable element and an adjustable handle which includes a distal gripping portion and a proximal mounting portion. The proximal mounting portion of the adjustable handle is connected to the rotatable element and the distal gripping portion of the adjustable handle is secured to the proximal mounting portion using a removable positioning fastener.

### FIELD OF THE INVENTION

The present specification relates generally to an unloading apparatus and more specifically to a trailer-like assistive unloading system with an adjustable handle and a rotatable element wherein rotation of the rotatable element facilitates unloading.

### BACKGROUND OF THE INVENTION

Load handler systems found among the prior art, like U.S. Pat. No. 5,340,266 for a ‘Pickup Truck Unloader’, are directed to being cost-effective alternatives to conventional dump trailers. Such systems may be comprised of a roller wheel with slip sheets wrapped around its length, with the roller wheel itself being attached to the tailgate of a pickup truck by plastic brackets on either of its ends. A fixed length crank handle attached to the roller is operable to rotate the roller, wherein rotation moves the slip sheet in the direction of the rotating roller, thereby depositing a load outside the periphery of the truck bed.

Unloader systems in the prior art can be useful in reducing the effort and time it takes to unload heavy or bulky construction materials. However, the designs of such systems present several limitations. Among these, load handler systems in the prior art require the presence of a tailgate to be stably secured during use and must be disassembled after each use and reassembled before subsequent use. Furthermore, unloader systems in the prior art use fixed length handles, the lengths of which are limited, that only permit full rotational cranking and additionally, the handles require repeated handle removal and repositioning for each unloading thereby providing an unergonomic design.

Accordingly, there remains a need for improvements in the art.

### SUMMARY OF THE INVENTION

In an embodiment of the present invention, there is provided an assistive transportation system comprising a trailer structure supported by wheels rotatably connected to the trailer structure, a rotatable element mounted on a pivot arm connected to a dispensing terminus of the trailer structure, a mat wound about the rotatable element, an adjustable handle comprised of a distal gripping portion and a proximal mounting portion, wherein the proximal mounting portion of the adjustable handle is connected to the rotatable element, and wherein the distal gripping portion of the adjustable handle is secured to the proximal mounting portion using a removable positioning fastener.

According to an embodiment, a method of dispensing a load using the same assistive transportation system comprises the steps of unwinding a load receiving terminal portion of the mat from the rotatable element such that the load receiving terminal portion of the mat covers a top surface of the trailer structure, placing the load onto the load receiving terminal portion of the mat, moving the assistive transportation system and the load from a first location to a second location, setting a length for the adjustable handle by inserting the removable positioning fastener into the adjustable handle, and rotating the adjustable handle to rotate the rotatable element to wind the load receiving portion of the mat about the rotatable element to displace the load from the trailer structure at the dispensing terminus

Among embodiments, there may be a trailer hitch, a pivotally mounted terminal enclosing structure, a position locking mechanism for the rotatable element or the pivot arm, a ratcheting mechanism connected to the rotatable element, a chain and sprocket system connected to the rotatable element, a motor and possibly a motor control system, a synchronization mechanism that rotates the rotatable element based on ground speed, a load sensor, or a combination of ground speed and a load sensor. The removable positioning fastener may be a spring pin, the rotatable element may have a mechanical torque receiving interface, and the adjustable handle may be adjusted between lengths of approximately 12 inches to 32 inches.

Among embodiments, there is a mat with a spray-on low friction coating to reduce friction between the load and the trailer bed during unloading.

Among embodiments, there may be a canopy system with an extendable covering that may define an internal volume for the trailer structure. Such a canopy system may be comprised of weather resistant material and the extendable covering may be stored at least in part within a box structure or tube structure on the trailer structure. A periphery of the extendable covering may be secured to a hole or grommet using clip-like or hooked fasteners and the extendable covering may be a distal terminal portion of the mat.

Other aspects and features according to the present application will become apparent to those ordinarily skilled in the art upon review of the following description of embodiments of the invention in conjunction with the accompanying figures.

### BRIEF DESCRIPTION OF THE FIGURES

The principles of the invention may be better understood with reference to the accompanying figures provided by way of illustration of an exemplary embodiment, or embodiments, incorporating principles and aspects of the present invention, and in which:

FIG. 1(a) shows a perspective view of a trailer-like assistive unloading system, according to an embodiment;

FIG. 1(b) shows a side view of a rotatable element mounted to a pivot arm attached to a trailer bed, according to an embodiment;

FIG. 1(c) shows a side view of a trailer-like assistive unloading system with a pivot pathway visualized for a pivot arm, according to an embodiment;

FIG. 1(d) shows a side view of a trailer-like assistive unloading system with a terminal enclosing element in an open configuration, according to an embodiment;

FIG. 1(e) shows a perspective view of an adjustable handle of a trailer-like assistive unloading system, according to an embodiment;

FIG. 1(f) shows a perspective view of a trailer-like assistive unloading system with a handle rotational pathway visualized for an adjustable handle, according to an embodiment;

FIG. 1(g) shows a frontside view of a trailer-like assistive unloading system, according to an embodiment;

FIG. 1(h) shows a backside view of a trailer-like assistive unloading system, according to an embodiment;

FIG. 1(i) shows a topside view of a trailer-like assistive unloading system, according to an embodiment;

FIG. 1(j) shows an underside view of a trailer-like assistive unloading system, according to an embodiment; and

FIG. 2 shows a perspective view of a rotatable element with a dual-stage ratcheting mechanism, according to an embodiment.

### DETAILED DESCRIPTION OF EMBODIMENTS OF THE INVENTION

The description that follows, and the embodiments described therein, are provided by way of illustration of an example, or examples, of particular embodiments of the principles of the present invention. These examples are provided for the purposes of explanation, and not of limitation, of those principles and of the invention. In the description, like parts are marked throughout the specification and the drawings with the same respective reference numerals. The drawings are not necessarily to scale and in some instances proportions may have been exaggerated to clarify certain features of the invention.

According to an embodiment, this description relates to an assistive transportation system comprising a trailer structure supported by a plurality of wheels rotatably connected to the trailer structure; a rotatable element mounted on a pivot arm connected to a dispensing terminus of the trailer structure; a mat wound about the rotatable element; an adjustable handle comprised of a distal gripping portion and a proximal mounting portion; wherein the proximal mounting portion of the adjustable handle is connected to the rotatable element; and wherein the distal gripping portion of the adjustable handle is secured to the proximal mounting portion using a removable positioning fastener.

According to embodiments of the invention, the present description relates to the assistive transportation system being comprised of a trailer hitch connected to the trailer structure, a terminal enclosing structure pivotally mounted to the dispensing terminus of the trailer structure, or a position locking mechanism for the rotatable element of the pivot arm. Embodiments may use at least one spring pin as the removable positioning fastener. Embodiments may be comprised of a dual-stage ratcheting mechanism connected to the rotatable element or a chain and sprocket system connected to the rotatable element.

According to embodiments of the invention, the rotatable element may have a mechanical torque receiving interface. Embodiments may be comprised of a motor connected to the rotatable element and may be comprised of a motor control system connected to the motor. Embodiments may be comprised of a synchronization mechanism connected to the rotatable element that rotates the rotatable element based on a ground speed of the assistive transportation system. The adjustable handle may have a length adjustable between approximately 12 inches to 32 inches.

According to embodiments of the invention, the assistive transportation system may be comprised of a canopy system with an extendable covering that may be positioned over the trailer structure to define an internal volume. Among embodiments, such a canopy system may be comprised of weather resistant material or stored within a box structure or a tube structure on the trailer structure. Among embodiments, a periphery of the extendable covering may be secured to a hole or grommet of the trailer structure using a clip-like fastener or a spring hook and the extendable covering may be a distal portion of the mat.

Embodiments of the invention may be comprised of a load sensor connected to the trailer structure or other electronics or computer systems. Load sensing may operate via the use of strain gauges positioned in the suspension of the trailer.

According to an embodiment, this description relates to a method of dispensing a load from an assistive transportation system comprising a trailer structure supported by a plurality of wheels rotatably connected to the trailer structure; a rotatable element mounted on a pivot arm connected to a dispensing terminus of the trailer structure; a mat wound about the rotatable element; an adjustable handle comprised of a distal gripping portion and a proximal mounting portion; wherein the proximal mounting portion of the adjustable handle is connected to the rotatable element; and wherein the distal gripping portion of the adjustable handle is secured to the proximal mounting portion using a removable positioning fastener, comprising the steps of unwinding a load receiving terminal portion of the mat from the rotatable element such that the load receiving terminal portion of the mat covers a top surface of the trailer structure; placing the load onto the load receiving terminal portion of the mat; moving the assistive transportation system and the load from a first location to a second location; setting a length for the adjustable handle by inserting the removable positioning fastener into the adjustable handle; and rotating the adjustable handle to rotate the rotatable element to wind the load receiving portion of the mat about the rotatable element to displace the load from the trailer structure at the dispensing terminus.

### Framing the Need for an Assistive Unloading System

The transport of high mass loads using a truck bed is ubiquitous both in commercial construction projects and home renovations. Nonetheless, there has been insufficient innovation directed to making the transfer of such loads more accessible to crews or individuals with limited human capital or who may otherwise wish to reduce the manual labor or costs associated with loading and unloading stones, sand, mulch, or other loads that may be of high mass.

There is also significant risk of inadvertent injury in transferring high mass loads. Such injuries may result from workplace accidents or may manifest over many years of repeated, high intensity labor. In minimizing the likelihood of work-related injuries, there is ample benefit to exploring alternatives to traditional loading and unloading systems which reduce the amount or intensity of manual labor associated with common work tasks, like the transfer of construction materials.

One common solution is the use of specialized vehicles, like the conjunctive use of a fleet of excavators and commercial dump trucks. While such vehicles can permit the loading and unloading of large amounts and masses of materials with a great degree of efficiency, purchasing or leasing such equipment can be prohibitively expensive for many projects. This is especially relevant where the loads to be transferred do not require the high loading capacities such vehicles offer.

As such, there is both practical and commercial value in developing transportation systems and tools that reduce labor burdens without necessitating substantial investment or an onerous assembly and disassembly mechanism.

According to an embodiment, there is a trailer-like assistive unloading system that reduces the manual labor associated with unloading a load. In designing embodiments of a trailer-like assistive unloading system, several key guiding principles were considered. These include, but are not limited to, providing a ready-to-use system that circumvents the need for complex installation or assembly and disassembly of parts, a mat and rotatable element wherein rotation of the rotatable element moves the mat such that a load positioned upon the mat is unloaded from a trailer, and an adjustable ergonomic handle that permits users to control requisite torque input and rotational speed of the assistive rotatable element or use ratcheting to dispense a load.

According to an embodiment, a trailer-like assistive unloading system provides an internal space suitable for carrying loads commonly associated with construction work or home renovations and a more accessible means of operation. In this regard, embodiments of the system permit users to safely and easily fulfil transportation tasks without the need for expensive, large-scale vehicles like dump trucks and excavators nor substantial human capital nor repeated assembly and disassembly of unloading devices. Embodiments of the trailer-like assistive unloading system may nonetheless be scalable and modular in design, such that embodiments may be directed to fulfilling specific transportation tasks that present different capacity demands or such that parts of the system are interchangeable with others to provide improved versatility.

### Devising an Assistive Unloading System

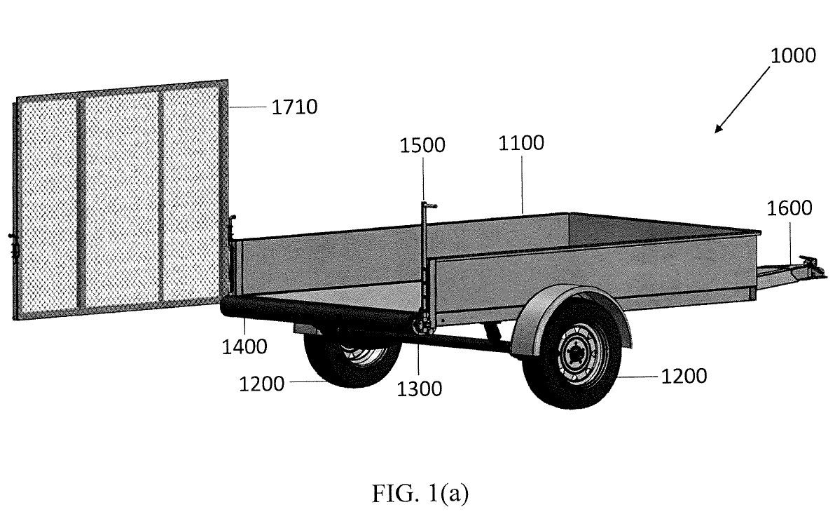

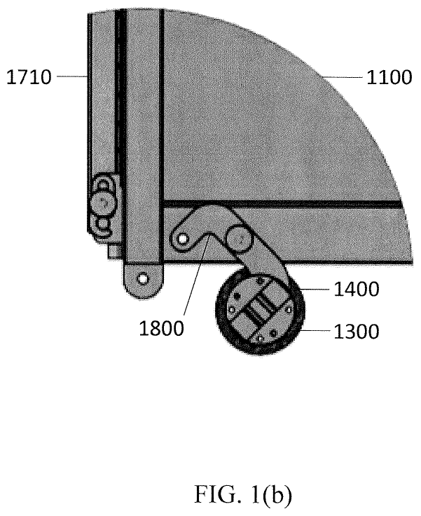

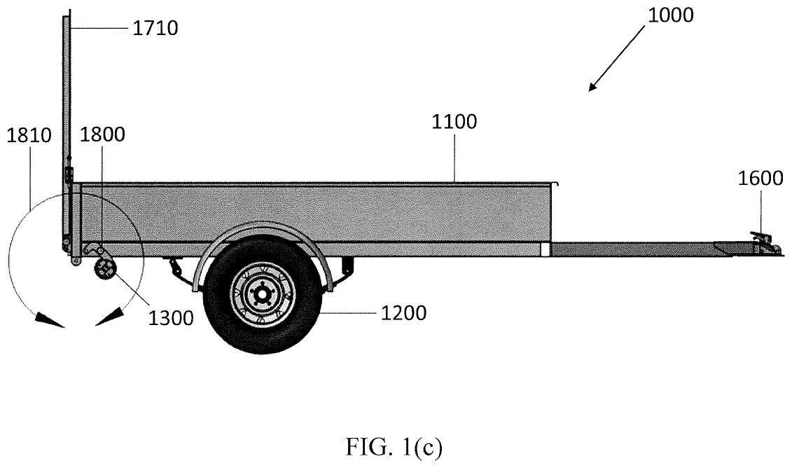

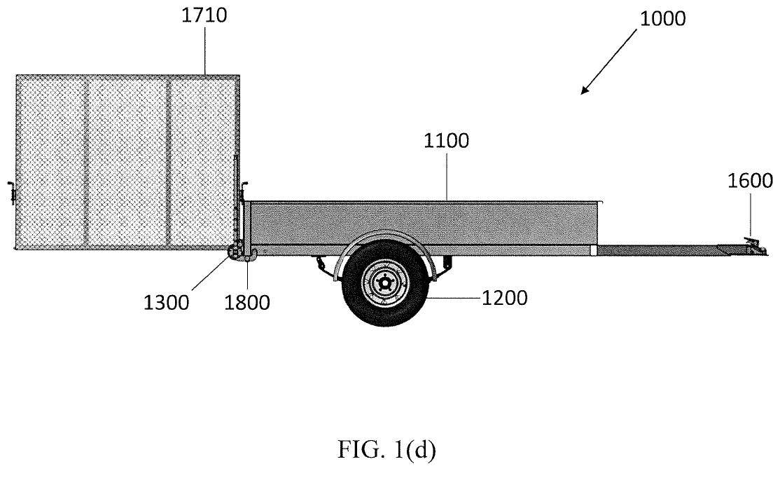

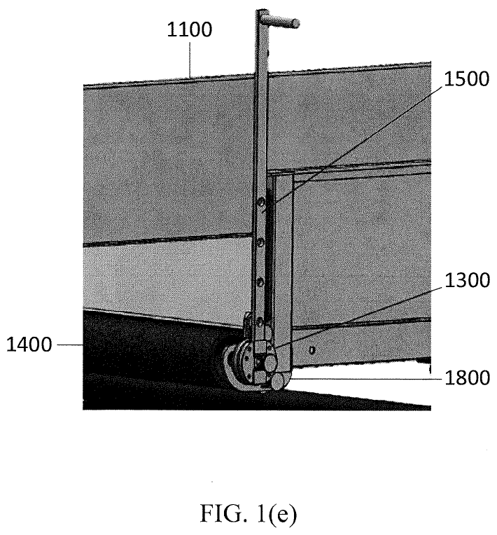

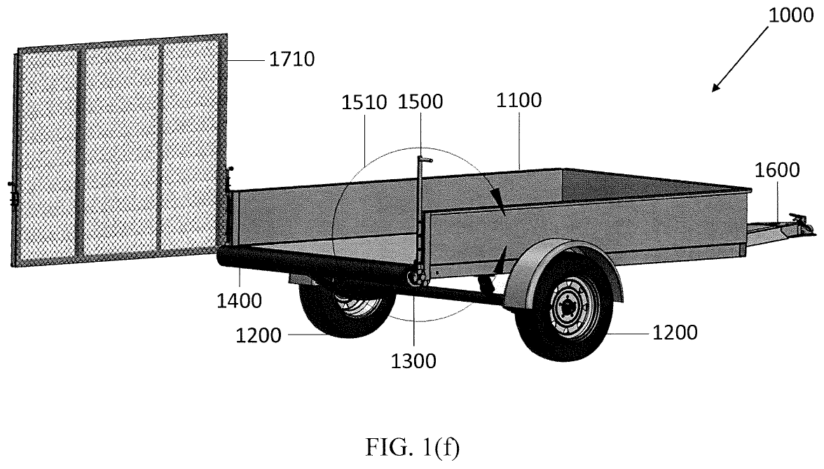

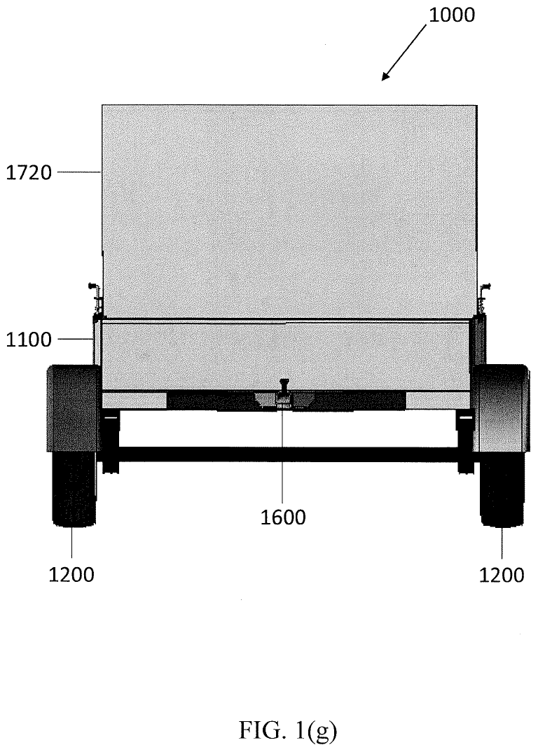

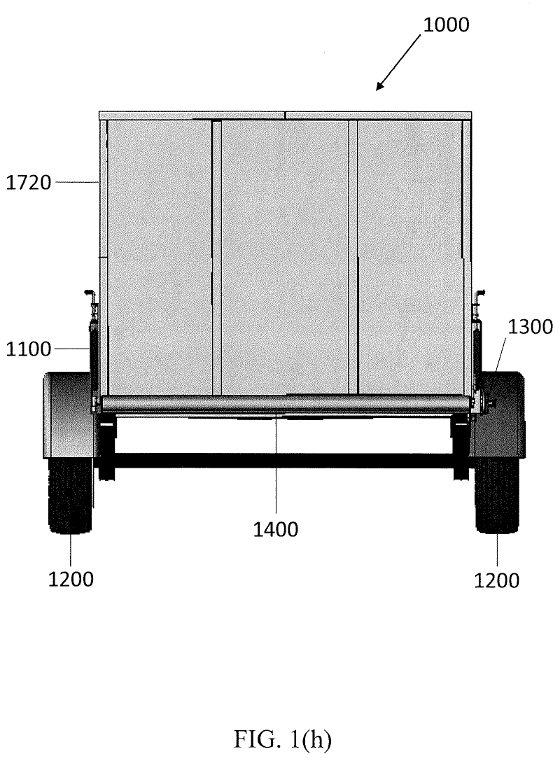

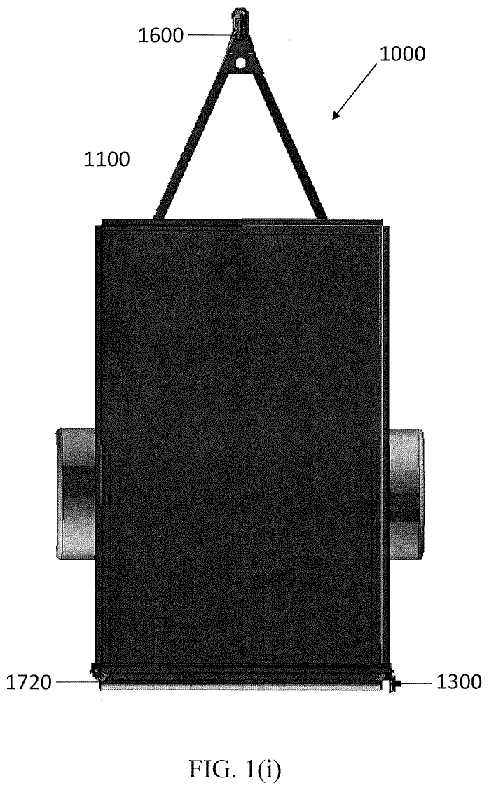

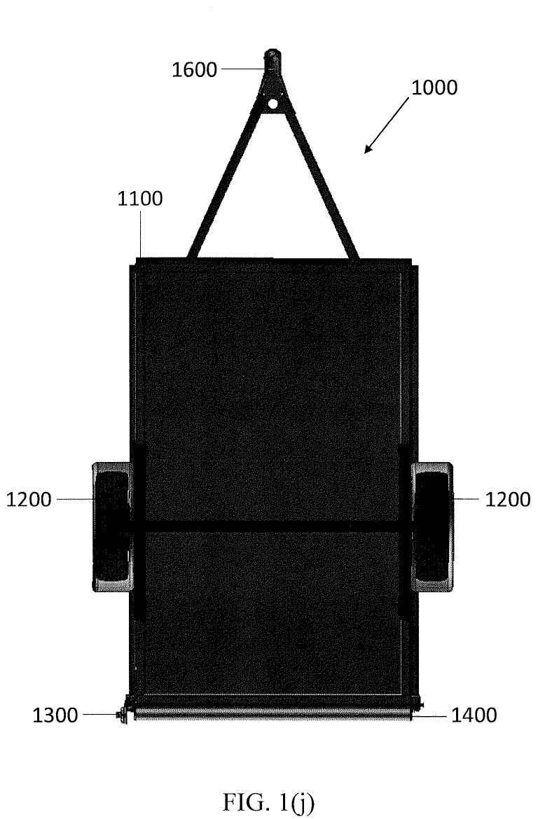

According to embodiments shown in FIGS. 1(a) to 1(j), there is a trailer-like assistive unloading system 1000. Trailer bed 1100 is supported by wheels 1200 and contains rotatable element 1300 whereupon a mat 1400 is rolled, such that rotation of the adjustable handle 1500 facilitates rotation of rotatable element 1300 and the winding or unwinding of mat 1400. In this regard, a load within the internal space defined by the trailer bed 1100 may be unloaded from the trailer bed 1100 by rotation of the adjustable handle 1500 where the mat 1400 is positioned to cover at least part of the internal space defined by the trailer bed 1100 and a load is positioned upon the mat 1400. Trailer bed 1100 may have a trailer hitch 1600 such that the trailer bed 1100 and any load thereupon may be towed for ease of transportation. Trailer bed 1100 may have a terminal enclosing structure 1710 or 1720 that may act as either a ramp or swing door.

As shown in FIGS. 1(b) to 1(e), the rotatable element 1300 may be mounted to the trailer bed 1100 using pivot arm 1800 such that the rotatable element 1300 may transition between active and stored positions. Particularly, pivot arm 1800 may be rotated about pivot pathway 1810 such that the active position extends the rotatable element 1300 beyond the periphery of the trailer bed 1100 so that adjustable handle 1500 may be rotated to roll or unroll the mat 1400 while minimizing the risk of inadvertent contact between the adjustable handle 1500 and the trailer bed 1100, thereby also reducing the risk of damage to either the trailer bed 1100 or adjustable handle 1500. Conversely, the pivot arm may be rotated in the opposite direction along pivot pathway 1810 such that the stored position secures the rotatable element 1300 near the underside of the trailer bed 1100. The pivot arm 1800 and rotatable element 1300 may be locked into either of the active position or stored position through use of a mechanical locking mechanism, fasteners, or a combination thereof.

As shown in FIGS. 1(a), 1(c), 1(d), and 1(f), the terminal enclosing structure 1710 may be an approximately planar metal grating and may operate as a ramp or be swung open to allow for effective unloading and unhindered material flow. As shown in FIGS. 1(g) to 1(i), the terminal enclosing structure 1720 may be an approximately planar solid metal structure that can similarly operate as a ramp or be swung open to facilitate unloading. Nonetheless, the design and comprising materials of the terminal enclosing structure may vary between embodiments of the invention, though a metal grating or solid metal terminal enclosing element may be preferred to safely secure a load.

The adjustable handle 1500 is of particular importance in reducing the manual labor required to transport a load using the assistive unloading system 1000. The effective length of the adjustable handle 1500 may be modified by using at least one spring pin that may be reversibly inserted into the adjustable handle 1500 to secure it in a variety of positions that correspond to different adjustable handle 1500 lengths. In this regard, the adjustable handle 1500 may operate in a high torque, heavy load rotational mode or a high speed, light load rotational mode for unloading. Such a design permits users to have greater control over the requisite force in operating the assistive unloading system 1000 and can help promote accessibility, reduce user strain, or otherwise make unloading larger masses easier. Movement of the adjustable handle 1500 along the handle rotational pathway 1510 shown in FIG. 1(f) permits a user to roll or unroll the mat 1400. Furthermore, adjusting the length of the adjustable handle 1500 can help reduce the risk of inadvertent contact between the adjustable handle 1500 and the trailer bed 1100 or a load, thereby also reducing the risk of damages or work-related injuries. According to a further embodiment, the adjustable handle 1500 may be of a length adjustable between approximately, but not limited to, 12 inches and 32 inches. The adjustable handle 1500 is longer in length when unloading a full load, and automatically shortens in length as the load gets lighter.

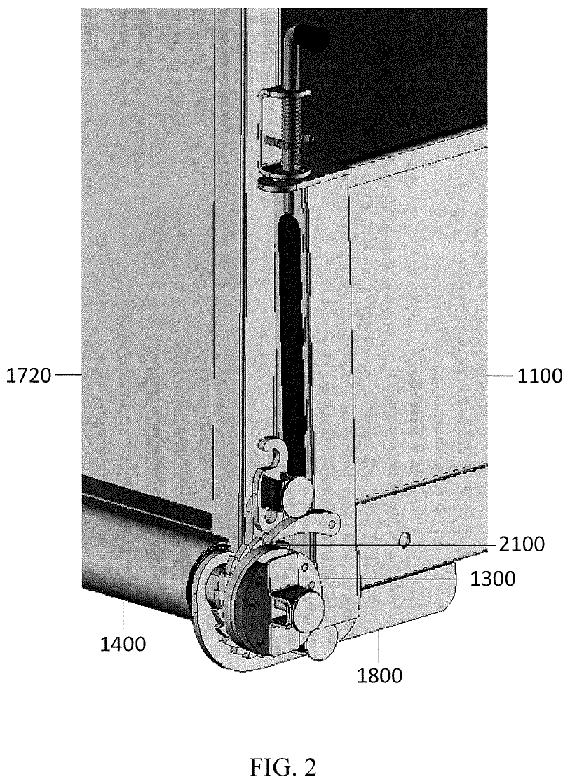

According to a further embodiment shown in FIG. 2, the rotatable element 1300 may include a dual-stage ratcheting mechanism 2100, with internal and external rotation such that the adjustable handle 1500 may be only partly rotated within the handle rotational pathway 1510 to effect rotation of the rotatable element 1300 and, thereby, roll or unroll the mat 1400. During unloading, the mat is under tension and may counter rotate. To combat the counter rotation, the dual-stage ratcheting mechanism inhibits backward rotation of the axle during ratcheting which allows for ergonomic rotation and easier unloading of the load.

### Adaptations of Assistive Loading Systems

According to an embodiment, a motor may be integrated into an assistive unloading system to help facilitate rotation of a rotatable element that winds or unwinds a mat and thereby displaces a load. Such a motorized system may be integrated at least in part into the trailer structure and may generally be embodied either as a mechanical system for receiving the rotational output of a separate tool or as a trailer-specific motor. Such embodiments would preferably incorporate a high torque motor and would eliminate or reduce the need for manual rotational input to operate an assistive unloading system. Where an external tool is used to provide torque, the rotatable element of the assistive unloading system may be machined to interface with some part of the external tool, such that torque generated by the tool is efficiently converted into torque applied to the rotatable element. While especially suitable for use with motorized external tools, non-motorized external tools may also interface with the rotatable element to permit operation or otherwise reduce requisite manual labour either alone or when used conjunctively with a motor or motorized tool. Embodiments may make use of a chain and sprocket, gears, belts, or similar torque multiplying systems to similarly reduce the manual effort required to rotate the rotatable element and thereby displace a load.

According to an embodiment, there may be a control system operable to facilitate loading or unloading of an assistive unloading system. In motorized embodiments, there may be a control switch located on the trailer structure or in the cab of a vehicle towing the trailer structure that may be activated by a user to facilitate rotation of the rotatable element of the assistive unloading system to displace a load. The control switch may merely offer the option to activate or deactivate the rotatable element or may also feature speed controls that permit users to control the rate at which a load is displaced. Embodiments with remote controls also permit users to more readily observe unloading, possibly in conjunction with using a mirror system, thereby providing more control over how a load is displaced.

According to an embodiment, the rate at which an assistive unloading system displaces a load may be determined in part by its ground speed. Embodiments may synchronize displacement of a load with ground speed such that a driver of a vehicle towing the assistive unloading system can control the rate of displacement of a load by controlling the speed at which the vehicle is travelling. This can be particularly useful in load spreading, especially so where a load is to be spread across an approximately linear surface area or other surface area upon which a vehicle may easily traverse. Embodiments may use at least one sensor to effect synchronization or may mechanically tie the rotation of the rotatable element to the rotation of the axles of a vehicle. Synchronization may be achieved with or without the use of motorized components.

According to an embodiment, an assistive unloading system may feature a canopy system that assists with storage or security of a load. In this regard, a trailer may be reversibly converted from an open trailer into a closed trailer by using the canopy system to create an internal volume. The canopy system may be comprised of a weather-resistant covering that may be stored within a tube or box structure at the front of a trailer when the trailer is in an open configuration. The covering may then be extended over the body of the trailer and secured to the trailer structure using fasteners, such as clip-like fasteners or spring-hooks in conjunction with predefined holes or grommets. In this regard, a user may manually pull or use a motorized system to extend the covering over the body of the trailer to define the internal volume and thereafter secure the covering using fasteners. Incorporating such a canopy system can help facilitate compliance with tarping laws which require certain loads that present a risk of becoming dislodged to be safely enclosed.

According to a further embodiment, the covering of the canopy system of an assistive unloading system may be a terminal portion of the mat otherwise wound about the rotatable element. In this regard, the surface area of the mat, particularly its length, may exceed the surface area of the trailer bed such that the distal terminus of the mat may be wrapped over a load. By using a mat with a length that is at least double the length of the trailer bed, the mat can be extended beyond the length of the trailer bed, a load positioned upon the mat within the trailer bed, and the distal terminus of the mat may be folded back over the load and secured using fasteners to provide a complete enclosure for the load.

Embodiments of the invention may incorporate sensors and communication systems to further improve functionality. According to an embodiment, a load sensor may be used to assess the weight of a load. The load sensor may interface with a feedback and control system, such that changes in weight may generate feedback that is communicated to a user or such that feedback is used at least in part to control load dispensing. Information pertaining to the rate at which a load is being dispensed may also be communicated to a user through an interface or an audio output to help determine whether unloading is occurring at a consistent rate.

Embodiments of the invention may also incorporate electronics or communication systems that permit users to understand, track, and analyze the operation of an assistive unloading system. A display and user interface may be provided such that a user can read and navigate among data associated with the assistive unloading system's use. Embodiments may constitute an Internet of Things device, wherein sensors and systems incorporated into the assistive unloading system may be communicatively coupled to internet-enabled devices. This can include the conjunctive use of a software application on a common mobile device, such that information pertaining to the assistive unloading system is communicated to and displayed upon the mobile device. Broader data analytics and fleet tracking for assistive unloading systems may also be performed with the use of such data collection and communication systems.

Various embodiments of the invention have been described in detail. Since changes in and or additions to the above-described best mode may be made without departing from the nature, spirit or scope of the invention, the invention is not to be limited to those details but only by the appended claims. Section headings herein are provided as organizational cues. These headings shall not limit or characterize the invention set out in the appended claims.

What is claimed is:

1. An assistive transportation system comprising:
a trailer structure supported by a plurality of wheels rotatably connected to the trailer structure;
a rotatable element mounted on a pivot arm connected to a dispensing terminus of the trailer structure;
a mat wound about the rotatable element;
an adjustable handle comprised of a distal gripping portion and a proximal mounting portion;
wherein the proximal mounting portion of the adjustable handle is connected to the rotatable element; and
wherein the distal gripping portion of the adjustable handle is secured to the proximal mounting portion using a removable positioning fastener.

2. The assistive transportation system of claim 1, further comprising a trailer hitch connected to the trailer structure.

3. The assistive transportation system of claim 1, further comprising a terminal enclosing structure pivotally mounted to the dispensing terminus of the trailer structure.

4. The assistive transportation system of claim 1, further comprising a position locking mechanism for the rotatable element or the pivot arm.

5. The assistive transportation system of claim 1, wherein the removable positioning fastener is a spring pin.

6. The assistive transportation system of claim 1, further comprising a dual-stage ratcheting mechanism connected to the rotatable element.

7. The assistive transportation system of claim 1, further comprising a chain, sprocket and gear system connected to the rotatable element.

8. The assistive transportation system of claim 1, wherein the rotatable element has a mechanical torque receiving interface.

9. The assistive transportation system of claim 1, further comprising a motor connected to the rotatable element.

10. The assistive transportation system of claim 9, further comprising a motor control system connected to the motor.

11. The assistive transportation system of claim 1, further comprising a synchronization mechanism connected to the rotatable element that rotates the rotatable element based on a ground speed of the assistive transportation system.

12. The assistive transportation system of claim 1, wherein the adjustable handle is auto-adjustable.

13. The assistive transportation system of claim 1, further comprising a canopy system with an extendable covering that may be positioned over the trailer structure to define an internal volume.

14. The assistive transportation system of claim 13, wherein the canopy system is comprised of weather resistant material.

15. The assistive transportation system of claim 13, wherein the extendable covering may be stored at least in part within a box structure or a tube structure on the trailer structure.

16. The assistive transportation system of claim 13, wherein a periphery of the extendable covering is secured to a hole or grommet of the trailer structure using a clip-like fastener or a spring hook.

17. The assistive transportation system of claim 13, wherein the extendable covering is a distal terminal portion of the mat.

18. The assistive transportation system of claim 1, further comprising a load sensor connected to the trailer structure.

19. A method of dispensing a load from an assistive transportation system comprising a trailer structure supported by a plurality of wheels rotatably connected to the trailer structure; a rotatable element mounted on a pivot arm connected to a dispensing terminus of the trailer structure; a mat wound about the rotatable element; an adjustable handle comprised of a distal gripping portion and a proximal mounting portion; wherein the proximal mounting portion of the adjustable handle is connected to the rotatable element;
and wherein the distal gripping portion of the adjustable handle is secured to the proximal mounting portion using a removable positioning fastener, comprising the steps of:
unwinding a load receiving terminal portion of the mat from the rotatable element such that the load receiving terminal portion of the mat covers a top surface of the trailer structure;
placing the load onto the load receiving terminal portion of the mat;
moving the assistive transportation system and the load from a first location to a second location;
setting a length for the adjustable handle by inserting the removable positioning fastener into the adjustable handle; and
rotating the adjustable handle to rotate the rotatable element with a dual-stage ratchet mechanism in order to wind the load receiving portion of the mat about the rotatable element to displace the load from the trailer structure at the dispensing terminus.
